(19) United States
(12) Patent Application Publication
(10) Pub. No.: US 2026/0332953 A1
(43) Pub. Date: Oct. 22, 2026

(54) ACOUSTIC SYSTEM

(71) Applicant: Nissan Motor Co., Ltd., Kanagawa (JP)

(72) Inventors: Kenji Tan, Kanagawa (JP); Kei Saito, Kanagawa (JP)

(73) Assignee: Nissan Motor Co., Ltd., Kanagawa (JP)

(21) Appl. No.: 19/158,343

(22) PCT Filed: Feb. 27, 2023
(86) PCT No.: PCT/JP2023/007141

§ 371 Date: Aug. 20, 2025

(51) Int. Cl. H04R 3/12; H04R 1/40; H04R 5/04; H04S 7/00

(52) U.S. Cl. CPC H04R 3/12; H04R 1/403; H04R 5/04; H04S 7/30; H04R 2420/01; H04R 2499/13

(57) ABSTRACT

An acoustic system includes: a sound source control device configured to output multiple sound source stream signals; and an amplifier configured to have at least the same number of sound inputs as the sound source stream signals, and drive speakers using the sound source stream signals input to each of the sound inputs. The sound source control device classifies sound sources greater in number than the sound source stream signals into multiple streams and outputs the sound source stream signals from multiple sound sources belonging to the streams for each stream. The amplifier determines the speakers to be driven and the sound source stream signals driving each speaker, based on a category of each sound source stream signal and a setting of a sound bubble.

### TECHNICAL FIELD

The present invention relates an acoustic system.

### BACKGROUND ART

Conventionally, there has been known an on-vehicle acoustic processing device which performs acoustic processing for simultaneously reproducing different sound sources in a vehicle interior space of a vehicle where multiple hearing positions exist (see Patent Literature 1).

### CITATION LIST

### Patent Literature

Patent Literature 1: JP 2018-170563 A

### SUMMARY OF INVENTION

### Problems to be Solved by Invention

A front seat sound source signal and a rear seat sound source signal are input to the on-vehicle acoustic processing device of Patent Document 1, and the speakers in the vehicle interior are driven using the sound source signals. The sound source signals are each output from multiple sound sources. For this reason, the on-vehicle acoustic processing device has the same number of sound source inputs as the sound sources, and needs to control the speakers to be driven for all the input sound source signals, thereby complicating the configuration of the device and the processing system of the sound source signals in some cases.

An object of the present disclosure is to provide an acoustic system that simplifies control of speakers by reducing the number of sound inputs to an amplifier.

### Solution to Solve Problems

An acoustic system according to an aspect of the present disclosure includes: a sound source control device configured to output multiple sound source stream signals; and an amplifier configured to have at least the same number of sound inputs as the sound source stream signals, and drive speakers using the sound source stream signals input to each of the sound inputs. The sound source control device classifies sound sources greater in number than the sound source stream signals into multiple streams, and outputs the sound source stream signals from multiple sound sources belonging to the streams for each stream. The amplifier determines the speakers to be driven and the sound source stream signals driving each speaker, based on a category of each sound source stream signal and a setting of a sound bubble.

### EFFECTS OF INVENTION

An aspect of the present disclosure makes it possible to provide an acoustic system that simplifies control of speakers by reducing the number of sound inputs to an amplifier.

### BRIEF DESCRIPTION OF DRAWINGS

FIG. 1A is a block diagram illustrating a configuration of a sound bubble control system 1000 including a sound bubble control device 100 and an acoustic system 300 according to a first embodiment.

FIG. 1B is a flowchart illustrating an example of a sound bubble control method using the sound bubble control device 100.

FIG. 2 illustrates a display layout of a touch panel 400 according to the first embodiment (part 1).

FIG. 3 illustrates another display example of a layout diagram 220 illustrating a seat arrangement of FIG. 2.

FIG. 4 illustrates the display layout of the touch panel 400 according to the first embodiment (part 2).

FIG. 5 illustrates the display layout of the touch panel 400 according to the first embodiment (part 3).

FIG. 6 illustrates the display layout of the touch panel 400 according to the first embodiment (part 4).

FIG. 7 illustrates a display layout of the touch panel 400 according to a second embodiment (part 1).

FIG. 8 illustrates the display layout of the touch panel 400 according to the second embodiment (part 2).

FIG. 9 illustrates the display layout of the touch panel 400 according to the second embodiment (part 3).

FIG. 10 illustrates the display layout of the touch panel 400 according to the second embodiment (part 4).

FIG. 11 illustrates the display layout of the touch panel 400 according to the second embodiment (part 5).

FIG. 12 is a block diagram illustrating a configuration of the acoustic system 300 according to a third embodiment.

FIG. 13A is a schematic diagram illustrating images of sound bubbles formed in a vehicle interior by the acoustic system 300 for each setting of the sound bubbles (part 1).

FIG. 13B is a schematic diagram illustrating images of the sound bubbles formed in the vehicle interior by the acoustic system 300 for each setting of the sound bubbles (part 2).

FIG. 14 is a schematic diagram illustrating a specific example of multiple sound sources 330 of FIG. 12, streams 331, 332, and 333 to which each sound source 330 belongs, and a category to which each sound source 330 belongs.

FIG. 15A is a part of a table (part 1) in which a combination of categories of sound sources belonging to three streams (Main, Mix 1, Mix 2) of FIG. 14 is classified by identifiers (1) to (45).

FIG. 15B is a part of the table (part 2) in which a combination of categories of sound sources belonging to three streams (Main, Mix 1, Mix 2) of FIG. 14 is classified by identifiers (1) to (45).

FIG. 15C is a part of the table (part 3) in which a combination of categories of sound sources belonging to three streams (Main, Mix 1, Mix 2) of FIG. 14 is classified by identifiers (1) to (45).

FIG. 15D is a part of the table (part 4) in which a combination of categories of sound sources belonging to three streams (Main, Mix 1, Mix 2) of FIG. 14 is classified by identifiers (1) to (45).

FIG. 16 is a part of a correspondence table illustrating a correspondence relationship between a combination of categories of sound sources classified by the identifiers (1) to (45) of FIGS. 15A to 15D, and speakers to be driven and streams of sound sources driving each speaker (part 1).

FIG. 17 is a part of a correspondence table illustrating a correspondence relationship between a combination of categories of sound sources classified by the identifiers (1) to (45) of FIGS. 15A to 15D, and speakers to be driven and streams of sound sources driving each speaker (part 2).

FIG. 18 is a part of a correspondence table illustrating a correspondence relationship between a combination of categories of sound sources classified by the identifiers (1) to (45) of FIGS. 15A to 15D, and speakers to be driven and streams of sound sources driving each speaker (part 3).

FIG. 19 is a part of a correspondence table illustrating a correspondence relationship between a combination of categories of sound sources classified by the identifiers (1) to (45) of FIGS. 15A to 15D, and speakers to be driven and streams of sound sources driving each speaker (part 4).

### DESCRIPTION OF EMBODIMENTS

### First Embodiment

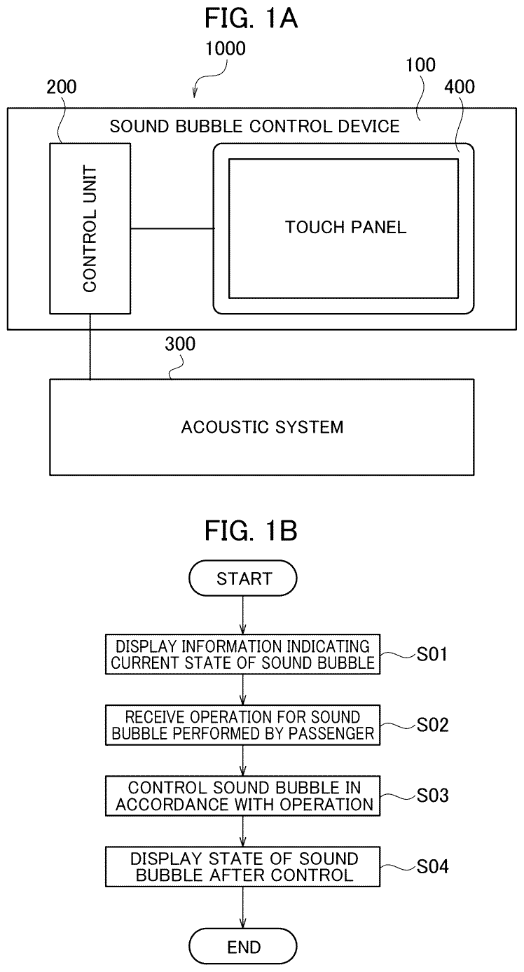

A sound bubble control system 1000 according to an embodiment is a system that controls sound bubbles by forming 1 or 2 or more sound bubbles in the vehicle interior space of a vehicle. The sound bubble indicates an area where a sound is heard in the vehicle interior. The sound includes a sound reproduced from multiple sound sources. As illustrated in FIG. 1A, the sound bubble control system 1000 includes an acoustic system 300 that forms sound bubbles by reproducing a sound using multiple speakers, and a sound bubble control device 100 that controls sound bubbles of multiple sound sources in accordance with operation performed by a passenger of a vehicle. The sound bubble control system 1000 forms various sound bubbles in the vehicle interior according to a category of sound sources and settings of sound bubbles.

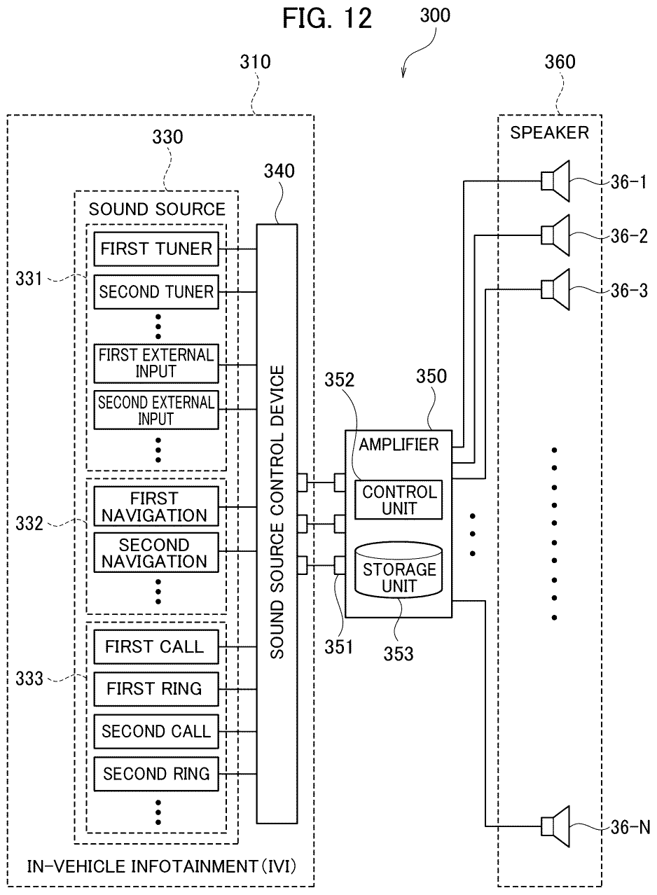

The sound bubble control device 100 includes a touch panel 400 and a control unit 200. The touch panel 400 is an example of a display which is arranged in the vehicle interior and displays information indicating a state of a sound bubble. The touch panel 400 has a function as a display, and a function as an input device for receiving a touch operation performed by a passenger of the vehicle. The control unit 200 can be implemented using a microcomputer having a CPU (central processing unit), a memory, and an input/output unit. A computer program (sound bubble control program) for making the microcomputer function as the control unit 200 is installed and executed in the microcomputer. Thus, the microcomputer functions as multiple information processing units provided in the control unit 200. Here, an example in which the control unit 200 is implemented by software will be described herein; however, it is also possible to configure the control unit 200 by preparing dedicated hardware for executing each information processing. In addition, the multiple information processing units included in the control unit 200 may be configured by individual hardware. Further, the control unit 200 may be configured by the same hardware as a sound source control device 340 (see FIG. 12) provided in the acoustic system 300. In addition, the control unit 200 can also be used as an electronic control unit (ECU) used for other vehicle-related controls.

An example of a sound bubble control method using the sound bubble control device 100 will be described with reference to FIG. 1B. The sound bubble control method is a procedure in which the control unit 200 operates in accordance with a sound bubble control program. In step S01, the control unit 200 displays information indicating a current state of the sound bubble on the touch panel 400. In step S02, the control unit 200 receives an operation for the sound bubble performed by a passenger of the vehicle. Specifically, the control unit 200 receives a touch operation performed by the passenger for the setting screen of the sound bubble displayed on the touch panel 400. After receiving the operation, the processing proceeds to step S03, and the control unit 200 controls the sound bubble in accordance with the received operation. Specifically, the control unit 200 transmits a signal indicating the setting of the sound bubble after the operation to the acoustic system 300. Upon receiving the signal, the acoustic system 300 determines the speakers to be driven and the sound source for driving each speaker based on the setting of the sound bubble after the operation, and drives the speakers. Thereafter, the processing proceeds to step S04, and the control unit 200 displays information indicating the state of the sound bubble after the control on the touch panel 400. The sound bubble control system 1000 forms various sound bubbles in the vehicle interior space according to the settings of the sound bubbles after the operation. By displaying the information indicating the current state of the sound bubble on the touch panel 400, it is possible to visually understand which sound source is reproduced at which hearing position in the vehicle interior. Therefore, the passenger can perform an operation for the sound bubble accurately (step S02). Further, in step S04, the information indicating the state of the sound bubble after the control is displayed on the touch panel 400. This makes it possible for the passenger to confirm an operation for the sound bubble accurately (step S02). Thus, the sound bubble control device 100 and the sound bubble control method enable the passenger to visually understand the state of the sound bubble, thereby performing an operation for the sound bubble accurately and efficiently.

A detailed configuration and a specific example of the operation of the acoustic system 300 will be described in a third embodiment. In the first embodiment, the detailed configuration and operation of the acoustic system 300 are not particularly required, and the existing acoustic system 300 which can implement a sound bubble after operation in the vehicle interior can be used.

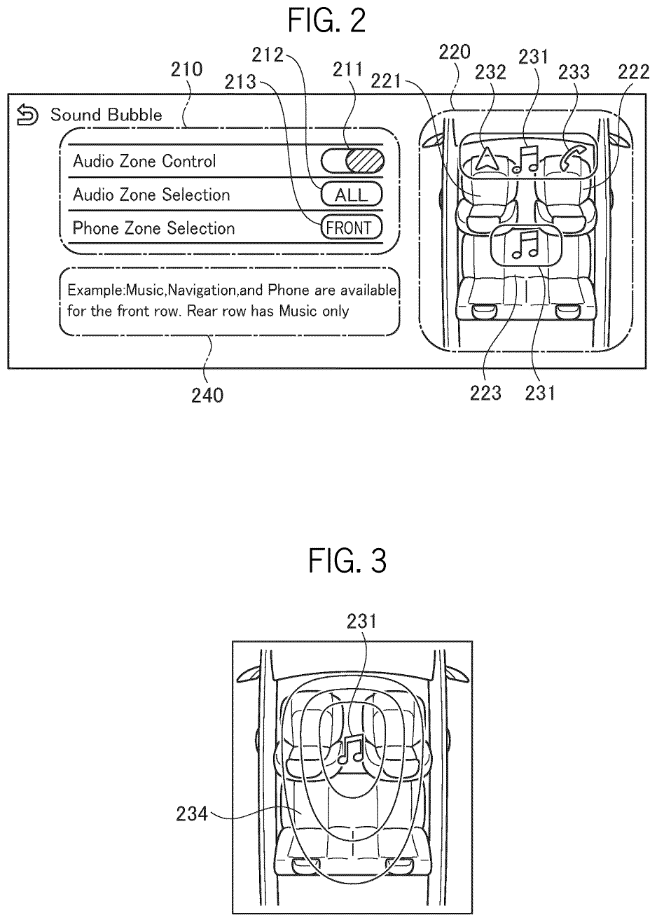

Referring to FIGS. 2 to 6, a display layout of the touch panel 400 and a specific operation method of a sound bubble according to the first embodiment will be described. FIGS. 2 to 6 are specific examples of “information indicating a state of a sound bubble” displayed on the screen of the touch panel 400 arranged in the vehicle interior in the respective steps S01 and S04 of FIG. 1B. The information indicating the state of the sound bubble includes the information indicating a correspondence relationship between the seat in the vehicle interior and the stream to which the sound source heard in the seat belongs. The multiple sound sources are classified into streams having a smaller number than the number of sound sources. By displaying the information indicating the correspondence relationship between the seat in the vehicle interior and the stream of the sound source heard in the seat on the touch panel 400, the passenger who has checked the touch panel 400 can visually understand which hearing position in the vehicle interior or which sound source of the stream is reproduced in which seat.

For example, as illustrated in FIG. 2, the information indicating the sound bubble includes a layout diagram 220 indicating the seat arrangement in the vehicle interior, and sound source icons 231, 232, and 233 which are superimposed on seats 221, 222, and 223 in the layout diagram 220 and indicate a stream of sound sources heard in the seats 221, 222, and 223. The layout diagram 220 is illustrated from the viewpoint of overseeing the entire vehicle interior from above the vehicle interior. According to the layout diagram 220 and the sound source icons 231, 232, and 233, the passenger can intuitively understand a stream of sound sources heard in each of the seats 221, 222, and 223. In other words, it is possible to intuitively understand a stream of sound bubbles formed in each of the seats 221, 222, and 223.

In the first embodiment, an example will be described in which the sound bubble is operated and controlled by dividing the seats in the vehicle interior into the front seats 221 and 222 and the rear seat 223. The front seats includes a driver seat 221 (left seat) and a passenger seat (right seat). As illustrated in FIG. 2, a music icon 231 indicating “music” which is one of the streams, a telephone icon 233 indicating “telephone” which is one of the streams, and a navigation icon 232 indicating “navigation” (it can be abbreviated as “navi” in some cases) which is one of the streams are superimposed on the front seats 221 and 222. By checking this display, the passenger can understand that in the front seats 221 and 222, the sound reproduced from the sound source belonging to the music, telephone, and navigation streams is heard. In other words, the passenger can understand that that the sound bubble of the sound source belonging to the music, telephone, and navigation streams is formed in the front seats 221 and 222.

Meanwhile, the music icon 231 is superimposed on the rear seat 223. By checking this display, the passenger can understand that in the rear seat 223, the sound reproduced from the sound source belonging to the music stream is heard. In other words, the passenger can understand that the sound bubble of the sound source belonging to the music is formed in the rear seat 223.

An input reception unit 210 which receives a touch operation for the touch panel 400 performed by the passenger may be displayed on the screen of the touch panel 400 in addition to “information indicating a state of a sound bubble”. The input reception unit 210 includes, for example, a start switch 211, a sound bubble selection switch 212, and a telephone selection switch 213. The passenger can operate the sound bubble by touching the switches 211, 212, and 213. In addition, the passenger can understand the state of the sound bubble before and after the operation through the state of the switches 211, 212, and 213. Therefore, the passenger can visually understand the state of the sound bubble and operate the sound bubble accurately through the input reception unit 210.

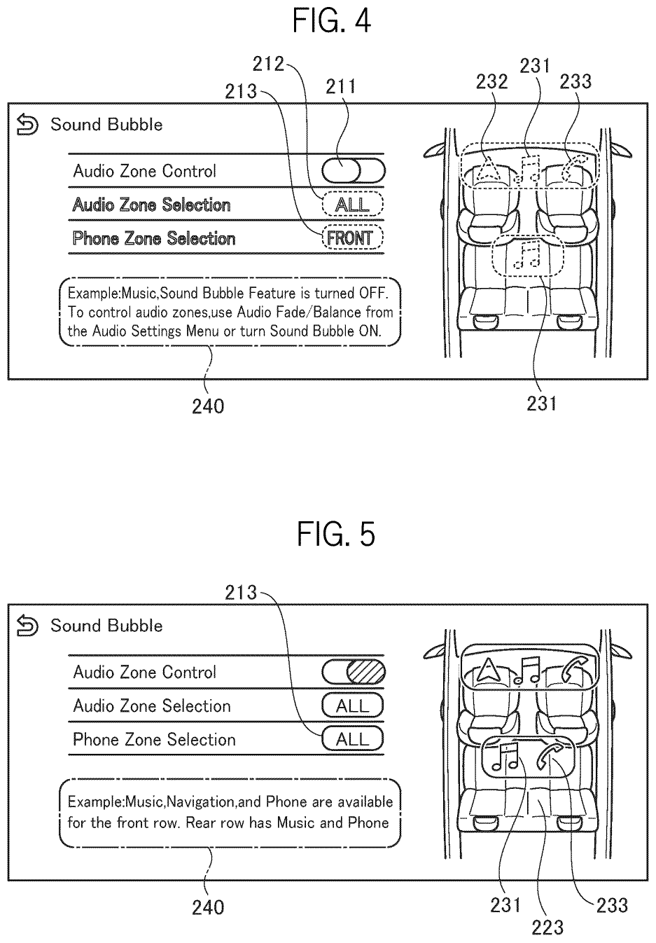

The start switch 211 is a switch corresponding to “Audio Zone Control” in FIGS. 2 and 4 to 6, and a switch that controls the start or stop of the sound bubble control device 100. Each time the passenger performs a touch operation, the sound bubble control device 100 is switched between the start and stop. As illustrated in FIG. 2, the start switch 211 positioned on the right side of the predetermined frame corresponds to a start state, and as illustrated in FIG. 4, the start switch 211 positioned on the left side of the predetermined frame corresponds to a stop state. The sound bubble control device 100 and the sound bubble control method display the information indicating the start or stop of the sound bubble control device 100 (start switch 211) on the touch panel 400, receive an operation for switching the start and stop of the sound bubble control device 100, switch the start and stop of the sound bubble control device 100 in accordance with the operation, and display the information indicating the start or stop of the sound bubble control device 100 after switching (start switch 211) on the touch panel 400. The passenger can visually understand the start state of the sound bubble control device 100, and operate the sound bubble control device 100 accurately.

The sound bubble control device 100 receives an operation for the sound bubble performed by the passenger only when the sound bubble control device 100 is started, and controls the sound bubble in accordance with the operation. For example, in the start state of FIG. 2, the information indicating the state of the sound bubble may be displayed in color. Specifically, the switches 211, 212, 213, and the sound source icons 231, 232, and 233 may be displayed in color. Thus, the passenger can intuitively understand that the sound bubble can be operated. Meanwhile, in the stop state of FIG. 4, the information indicating the state of the sound bubble may be displayed in gray. Specifically, the switches 211, 212, and 213, and the sound source icons 231, 232, and 233 may be grayed out. Thus, the passenger can intuitively understand that the sound bubble cannot be operated. Here, the color of either of the switches 211, 212, and 213 or the sound source icons 231, 232, and 233 may be switched, or the color of only some of the switches 211, 212, and 213 and only some of the sound source icons 231, 232, and 233 may be switched.

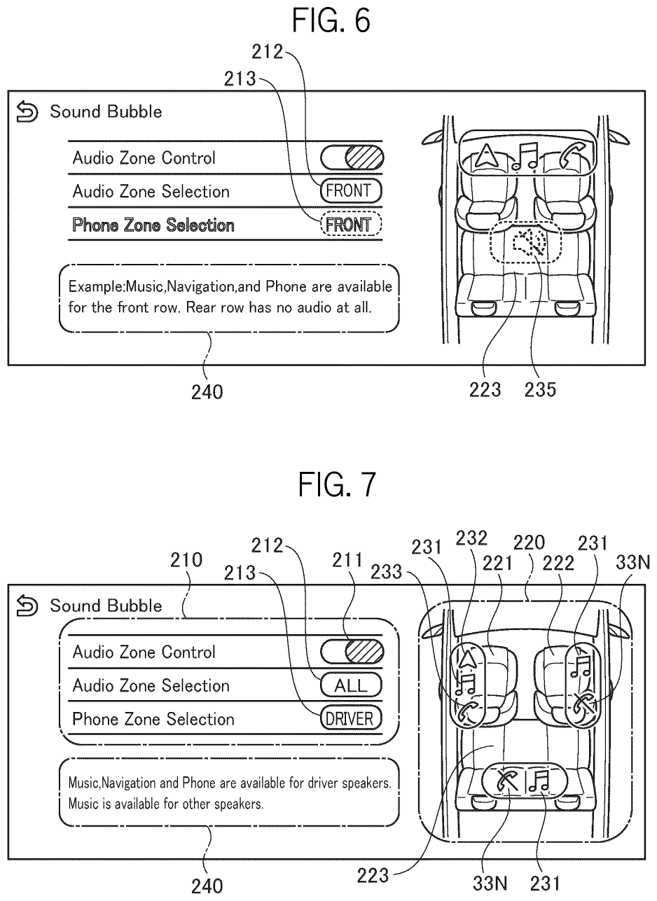

The sound bubble selection switch 212 is a switch corresponding to “Audio Zone Selection” of FIGS. 2 and 4 to 6, and is an example of displaying in a switchable manner, a first sound bubble in which a sound is heard in all the seats 221, 222, and 223 in the vehicle interior, and a second sound bubble in which a sound is heard in the driver seat 221 and the passenger seat 222 in the vehicle interior and a sound is not heard in the rear seat 223 in the vehicle interior. Each time the passenger performs a touch operation for the sound bubble selection switch 212, the first sound bubble and the second sound bubble are switched. As illustrated in FIGS. 2 and 5, the sound bubble selection switch 212 is displayed as “ALL” in the state of the first sound bubble, and as illustrated in FIG. 6, the sound bubble selection switch 212 is displayed as “FRONT” in the state of the second sound bubble. As illustrated in FIGS. 2, 5, and 6, the sound bubble selection switch 212 indicates the state of the sound bubble (ALL/FRONT). Therefore, the passenger can visually understand the current state of the sound bubble or the state of the sound bubble after the operation from the state of the sound bubble selection switch 212, and operate the sound bubble accurately. Further, the sound source icons 231, 232, and 233 displayed in the layout diagram 220 may be changed along with the state of the sound bubble selection switch 212. Specifically, as illustrated in FIGS. 2 and 5, the sound source icons 231 and 233 may be displayed so as to be superimposed on the rear seat 223 in the state of the first sound bubble (ALL).

Meanwhile, as illustrated in FIG. 6, a mute icon 235 may be displayed in the rear seat 223 in the state of the second sound bubble (FRONT), indicating that the sound is not heard, that is, a mute state in which the sound bubble is not formed. Thus, the passenger can intuitively understand that the sound bubble is in a mute state in which the sound bubble is not formed. Instead of the mute icon 235, a sound source icon may not be displayed on the rear seat 223. Note that the sound bubble selection switch 212 can switch the first sound bubble and the second sound bubble for sound sources of all streams regardless of a stream of sound sources.

Meanwhile, the telephone selection switch 213 is a switch corresponding to “Phone Zone Selection” of FIGS. 2 and 4 to 6, and is a switch for switching the sound bubble of the sound source belonging to the telephone between a first sound bubble in which a sound is heard in all the seats 221, 222, and 223 and a second sound bubble in which a sound is heard in the driver seat 221 and the passenger seat 222 in the vehicle interior and a sound is not heard in the rear seat 223 in the vehicle interior. When the sound bubble of the sound source belonging to the telephone is the second sound bubble, as illustrated in FIG. 2, the telephone selection switch 213 is displayed as “FRONT”, and when the sound bubble of the sound source belonging to the telephone is the first sound bubble, as illustrated in FIG. 5, the telephone selection switch 213 is displayed “ALL”. Since the telephone selection switch 213 indicates the state of the sound bubble (ALL/FRONT), the passenger can visually recognize the state of the sound bubble of the sound source belonging to the telephone from the telephone selection switch 213. In addition, the sound source icons 231, 232, and 233 displayed in the layout diagram 220 may be changed along with the state of the telephone selection switch 213. Specifically, when the first sound bubble (ALL) is selected in the telephone selection switch 213, as illustrated in FIG. 5, the telephone icon 233 may be displayed so as to be superimposed on both the front seats and the rear seat 223. Meanwhile, when the second sound bubble (FRONT) is selected in the telephone selection switch 213, as illustrated in FIG. 2, the telephone icon 233 is displayed so as to be superimposed on the front seats 221 and 222, but the telephone icon 233 is not displayed in the rear seat 223. Here, in FIG. 2, since the first sound bubble (ALL) is selected in the sound bubble selection switch 212, the music icon 231 is displayed so as to be superimposed on the rear seat 223. In FIG. 6, since the second sound bubble (FRONT) is selected in the sound bubble selection switch 212, only the second sound bubble (FRONT) can be selected in the telephone selection switch 213. In this case, as illustrated in FIG. 6, the telephone selection switch 213 may be displayed in gray color when the second sound bubble (FRONT) is selected in the sound bubble selection switch 212. Thus, the passenger can intuitively understand that the sound bubble of the sound source belonging to the telephone cannot be operated.

As illustrated in FIG. 2 and FIGS. 4 to 6, the information indicating the state of the sound bubble may include a sentence 240 explaining a correspondence relationship between the seats 221, 222 and 223 in the vehicle interior and the stream to which the sound sources heard in the seats 221, 222 and 223 belongs. As illustrated in FIGS. 2 and 4 to 6, the content of the sentence 240 changes according to the state of the sound bubble. For example, in the state of the sound bubble illustrated in FIG. 2, the sentence 240 indicating that “sound of sound source belonging to music, navigation and telephone can be heard in the front seat. Music only can be heard in the rear seat.” may be displayed on the screen of the touch panel 400. In FIG. 4, the sentence 240 indicating that “the sound bubble control unit is in a stop state. In order to control the sound bubble, use the sound control menu or start the sound bubble control device.” may be displayed. In FIG. 5, the sentence 240 indicating that “sound of sound source belonging to music, navigation and telephone can be heard in the front seat. Music and telephone are available in the rear seat.” may be displayed. In FIG. 6, the sentence 240 indicating that “sound of sound source belonging to music, navigation and telephone can be heard in the front seat. Sound of any sound source cannot be heard in the rear seat.” may be displayed. The passenger can visually understand the current state of the sound bubble or the state of the sound bubble after the operation from the content of the sentence 240, and operate the sound bubble accurately.

As illustrated in FIG. 3, an animation 234 in which ripples spread may be displayed around the sound source icon reproducing the sound. Specifically, the animation 234 illustrating the outer edges of the space in which the sound spreads may be displayed around the sound source icons 231, 232 and 233 in which the sound is actually reproduced from the speaker. The passenger can intuitively recognize a stream of sound sources being reproduced. The animation 234 may be displayed in each of the three icons 231, 232 and 333 displayed in the front seats 221 and 222 of FIG. 2, for example. Alternatively, the three icons 231, 232 and 333 may be regarded as one icon, and the animation 234 may be displayed around the icons. Further, the animation 234 may be controlled to be displayed while the vehicle is stopped and not to be displayed while the vehicle is running. Accordingly, the driver's attention can be maintained while the vehicle is running.

In the first embodiment, the sound bubble of the sound source belonging to the navigation is not an object for operation and control. However, the sound bubble of the sound source belonging to the navigation may be an object for operation and control in the same manner as the sound bubble of the sound source belonging to other streams such as music and telephone.

### Second Embodiment

In the second embodiment, a description will be given regarding an example in which the sound bubble in the vehicle interior is switched between a first sound bubble in which the sound is heard in all the seats in the vehicle interior and a third sound bubble in which the sound is heard in the driver seat and the sound is not heard in the seats other than the driver seat, that is, the passenger seat and the rear seat. Since the configuration of the sound bubble control device 100 and the procedure for the sound bubble control method illustrated in FIGS. 1A and 1B are the same as those in the first embodiment, and a repeated description thereof will be omitted.

Referring to FIGS. 7 to 11, a display layout of the touch panel 400 and a specific operation method of a sound bubble according to the second embodiment will be described. As illustrated in FIG. 7, the information indicating a state of a sound bubble is displayed on the screen of the touch panel 400. As an example of the information indicating the state of the sound bubble, the layout diagram 220 in which the sound source icons are superimposed, the input reception unit 210, and the sentence 240 are displayed on the screen of the touch panel 400. The input reception unit 210 includes the start switch 211, the sound bubble selection switch 212, and the telephone selection switch 213. Since the operation of the start switch 211 and the sound bubble selection switch 212, and the sentence 240 are the same as those of the first embodiment, a repeated description thereof will be omitted.

In the second embodiment, an example will be described in which the sound bubble is operated and controlled by dividing the seats in the vehicle interior into three sections: the driver seat 221 (left seat), the passenger seat 222 (right seat), and the rear seat 223. Various sound source icons are superimposed on each of the driver seat 221, the passenger seat 222, and the rear seat 223 in the layout diagram 220. In addition, each of the driver seat 221, the passenger seat 222, and the rear seat 223 is colored in a different color, and the sound source icon is also colored in a color similar to the color of the seat. This makes it possible to intuitively understood that the different sound bubbles are formed in the three seats.

The phone selection switch 213 is a switch corresponding to “Phone Zone Selection” illustrated in FIGS. 7 to 11. The telephone selection switch 213 is a switch for switching the sound bubble of the sound source belonging to the telephone between the first sound bubble and the third sound bubble. In the state of the first sound bubble, the sound of the sound source belonging to the telephone is heard in all the seats 221, 222 and 223. In the state of the third sound bubble, the sound of the sound source belonging to the telephone is heard in the driver seat 221 in the vehicle interior, but not heard in the passenger seat 222 and the rear seat 223 in the vehicle interior.

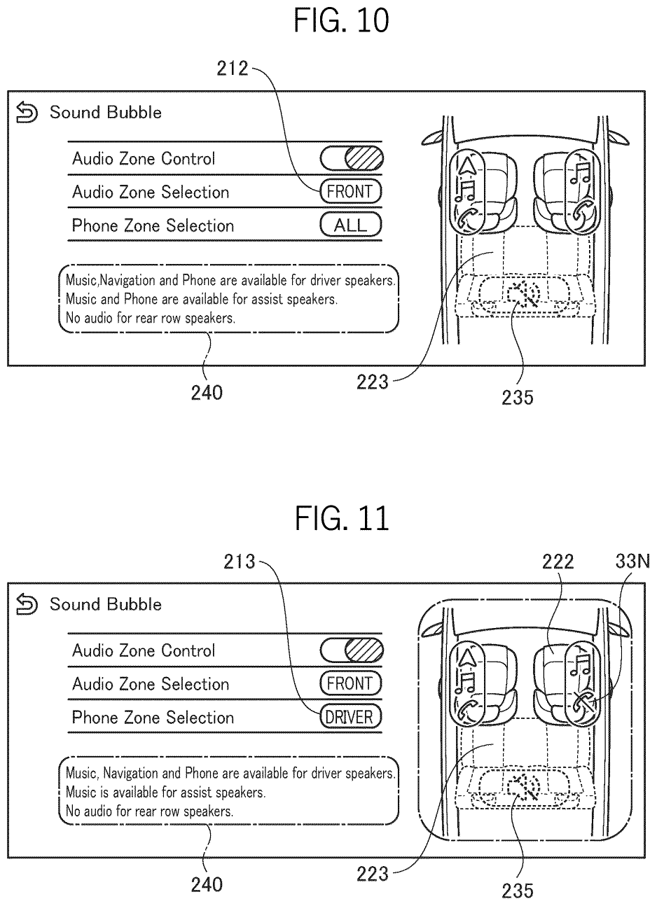

As illustrated in FIGS. 7 and 11, when the sound bubble of the sound source belonging to the telephone is the third sound bubble, the telephone selection switch 213 is displayed as “DRIVER”, and when the sound bubble of the sound source belonging to the telephone is the first sound bubble, as illustrated in FIGS. 9 and 10, the telephone selection switch 213 is displayed as “ALL”. Each time the passenger performs a touch operation for the sound bubble selection switch 212, the first sound bubble and the third sound bubble are switched. Since the telephone selection switch 213 indicates the state of the sound bubble (ALL/DRIVER), the passenger can visually understand the state of the sound bubble of the sound source belonging to the telephone from the telephone selection switch 213, and operate the sound bubble of the sound source belonging to the telephone accurately.

Further, the telephone icon 233 displayed in the layout diagram 220 may be changed along with the state of the telephone selection switch 213. Specifically, as illustrated in FIG. 9, when the first sound bubble (ALL) is selected in the telephone selection switch 213, the telephone icon 233 may be displayed so as to be superimposed on each of the driver seat 221, the passenger seat 222, and the rear seat 223. Meanwhile, as illustrated in FIG. 7, when the third sound bubble (DRIVER) is selected in the telephone selection switch 213, the telephone icon 233 may be displayed so as to be superimposed on the driver seat 221, and a telephone mute icon 33N may be displayed in the passenger seat 222 and the rear seat 223, indicating that the sound of the sound source belonging to the telephone cannot be heard, that is, the sound bubble of the sound source belonging to the telephone is not formed. Instead of displaying the telephone mute icon 33N, neither of the icons 233 and 33N related to the telephone may be displayed in the passenger seat 222 and the rear seat 223.

Since “ALL” is displayed in the sound bubble selection switch 212 illustrated in FIGS. 7 and 9, the sound bubble is formed in all the seats in the vehicle interior. Therefore, the music icon 231 is displayed so as to be superimposed on each of the driver seat 221, the passenger seat 222 and the rear seat 223. Meanwhile, since “FRONT” is displayed in the sound bubble selection switch 212 illustrated in FIGS. 10 and 11, the sound bubble is formed in the front seats in the vehicle interior, that is, the driver seat 221 and the passenger seat 222, but not formed in the rear seat 223. In the first embodiment, as illustrated in FIG. 6, the telephone selection switch 213 is a switch for performing a switching operation between the front seats and all seats. Therefore, when the second sound bubble (FRONT) is selected in the sound bubble selection switch 212, the telephone selection switch 213 cannot be operated. However, in the second embodiment, the telephone selection switch 213 is a switch for performing a switching operation between the driver seat and all seats. Therefore, as illustrated in FIGS. 10 and 11, the telephone selection switch 213 can be operated even if the second sound bubble (FRONT) is selected in the sound bubble selection switch 212. However, since the sound bubble selection switch 212 has priority over the telephone selection switch 213, even if the second sound bubble (FRONT) is selected in the sound bubble selection switch 212 and the first sound bubble (ALL) is selected in the telephone selection switch 213, as illustrated in FIG. 10, the sound bubble of the sound source belonging to the telephone is formed in the driver seat 221 and the passenger seat 222, but not formed in the rear seat 223.

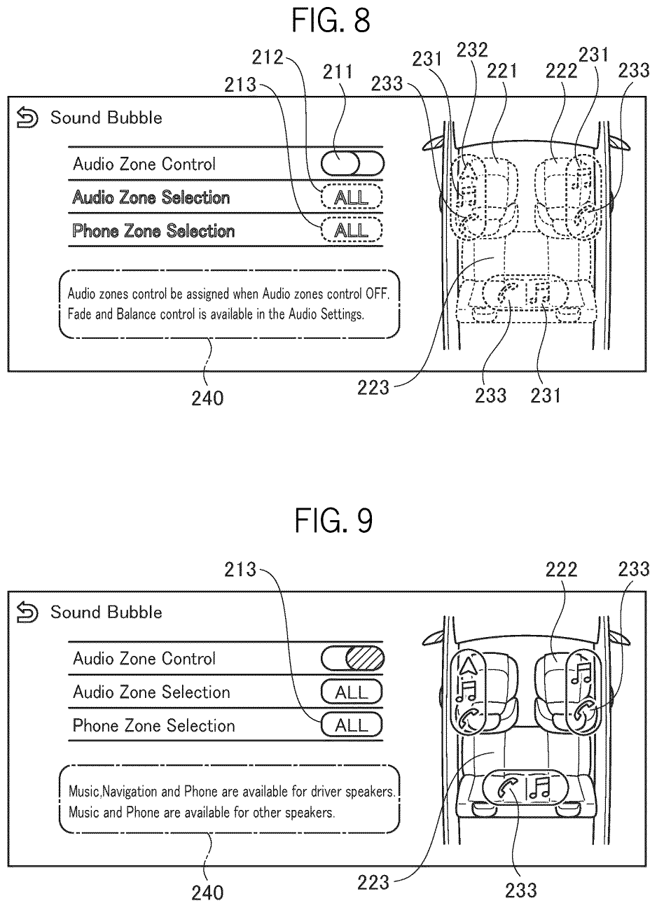

As illustrated in FIG. 8, when the start switch 211 is in the stop position and the sound bubble control device 100 is in the stop state, the information indicating the state of the sound bubble may be displayed in gray. Specifically, the switches 211, 212, and 213 and the sound source icons 231, 232, and 233 may be grayed out. Thus, the passenger can intuitively understand that the sound bubble cannot be operated. Here, the color of either of the switches 211, 212, and 213 or the sound source icons 231, 232, and 233 may be switched, or the color of only some of the switches 211, 212, and 213 and only some of the sound source icons 231, 232, and 233 may be switched.

Further, in the second embodiment, the sound bubble of the sound source belonging to the navigation is not an object for operation. The sound of the sound source belonging to the navigation is output to the driver like a guide sound related to a route guidance. Therefore, as illustrated in FIGS. 7 to 11, the navigation icon 232 is superimposed on the driver seat 221, and the navigation icon 232 is not superimposed on the passenger seat 222 and the rear seat 223. However, the sound bubble of the sound source belonging to the navigation may be an object for operation and control in the same manner as the sound bubble of the sound source belonging to other streams such as music and telephone.

Although the first and second embodiments have been described as above, it should not be understood that the statements and drawings which form a part of this disclosure limit the invention. From this disclosure, various alternative embodiments, examples and operation techniques will become apparent to those skilled in the art.

Although the case has been described in which the streams to which the sound sources belong include music, navigation, and telephone, there may be sound sources that belong to other streams. In addition, in the layout diagram 220, a description has been given regarding an example in which a sound source icon indicating a stream of sound sources in which a sound bubble is formed is displayed for each seat. However, the present disclosure is not limited thereto, and instead of displaying the sound source icon, an animation such as colors, patterns, or ripples for specifying a stream of sound sources may be added to the seats. Alternatively, the characters for specifying a stream of sound sources such as “MUSIC”, “NAVIGATION”, or “PHONE” may be superimposed on the seats.

A switch capable of selecting a fourth sound bubble in which a sound reproduced from all sound sources is heard in the driver seat 221 in the vehicle interior and not heard in the other seats 222 and 223 in the vehicle interior except for the driver seat 221 may be displayed on the touch panel 200. An operation for selecting the fourth sound bubble performed by the passenger can be received. Thus, the passenger can operate the sound bubble in the vehicle interior, using the fourth sound bubble.

The sound bubble control device 100 may collect an utterance of the passenger seated in the seat where the sound reproduced from the sound source belonging to the telephone is not heard, and switch the sound bubble such that the sound is heard in the seat where the sound is not heard, based on the result of the sound recognition of the content of the utterance. Further, the sound bubble control device 100 may display on the touch panel 200, the information indicating the state of the sound bubble after switching. For example, a microphone for collecting the utterance of the passenger seated in the passenger seat 222 or the rear seat 223 is installed in the vehicle interior. The control unit 200 recognizes the utterance of the passenger collected by the microphone using an existing sound recognition technology. For example, when a predetermined keyword such as “telephone”, “call”, “wish to participate”, or “wish to talk together” is found in the recognized sound, the control unit 200 determines that the passenger has an intention to participate in the telephone conversation. In this case, the control unit 200 switches the sound bubble such that the sound is heard in the seat where the sound is not heard without waiting for the touch operation performed by the passenger. The sound bubble control device 100 can control the sound bubble according to the intention of the passenger to participate in the telephone conversation. In addition, the passenger can visually understand the state of the sound bubble after the control.

In the first and second embodiments described above, the touch panel 400 is taken as an example of a display, and the touch operation to the touch panel 400 is taken as an operation example of a sound bubble performed by a passenger of the vehicle. However, the display which displays the information indicating the state of the sound bubble may be the display which does not have the function as a position input device such as a touch pad. In this case, instead of the touch operation to the touch panel 400, the passenger can operate the sound bubble by using his/her own sound, using a known sound recognition technology, or can operate the sound bubble by using another input device attached to the vehicle such as a steering switch or a switch provided on the instrument panel. That is, the sound bubble control device 100 may receive an operation for the sound bubble, using the passenger's sound or other input devices.

### Third Embodiment

In the third embodiment, a configuration example and an operation example of the acoustic system 300 included in the sound bubble control system 1000 illustrated in FIG. 1A will be described. The acoustic system 300 forms a sound bubble in the vehicle interior by reproducing a sound using multiple speakers based on the setting of the sound bubble specified by the operation of the passenger received by the sound bubble control device 100.

The configuration of the acoustic system 300 according to the third embodiment will be described with reference to FIG. 12. The acoustic system 300 includes a sound source control device 340 and an amplifier 350. The sound source control device 340 outputs multiple sound source stream signals. The amplifier 350 has at least the same number of sound inputs 351 as the sound source stream signals and drive multiple speakers 360 installed in the vehicle using the sound source stream signals input to each of the sound inputs 351. The sound source control device 340 classifies the sound sources 330 greater in number than the sound source stream signals into the same number of multiple streams 331 to 333 as the sound source stream signals, and outputs the sound source signals output from the multiple sound sources 330 belonging to the streams 331 to 333 for each stream 331 to 333 as the sound source stream signals. The amplifier 350 determines the speakers 360 to be driven and the sound source stream signals driving each speaker 360 based on the category of each sound source stream signal and the setting of the sound bubble in the vehicle interior. The multiple speakers 360 respectively convert the sound source stream signals received from the amplifier 350 into the sounds and output them. The “sound bubble” in the third embodiment is an area in the vehicle interior where the sound reproduced from the multiple speakers 360 is heard. The sound bubble is formed in the whole or a part of the vehicle interior. In addition, two or more sound bubbles with different sound sources can be formed simultaneously.

The number of sound source stream signals smaller than the number of sound sources 330 are respectively input to the sound inputs 351 of the amplifier 350. The amplifier 350 determines the speakers 36-1 to 36-N to be driven and the sound source stream signals driving the speakers 36-1 to 36-N based on the category of each sound source stream signal and the setting of the sound bubble. Therefore, the number of sound inputs to the amplifier 350 becomes smaller than the number of sound sources 330, thereby simplifying the control of the multiple speakers 360 using the amplifier 350. N indicates the number of speakers and is a natural number of 2 or more.

In the third embodiment, the number of each component is exemplified as follows. The number of sound source stream signals output from the sound source control device 340 is assumed to be 3. The sound source control device 340 classifies the sound sources 330 into three streams 331 to 333 which are the same as the number of sound source stream signals. The amplifier 350 has three sound inputs 351 which are the same as the number of sound source stream signals.

### <Counting of Signals and Sound Inputs>

The counting of the number of sound source stream signals and sound inputs 351 will be described. When the sound source 330 is a monaural sound source, the reproduction sound is monaural, and the signal generated from one sound source 330 has one type of waveform. Meanwhile, when a stereo sound source (including 2 channel stereo, binaural, surround, 4 channel stereo, 5.1 channel stereo, etc.) is reproduced in stereo, the signal generated from one sound source 330 has two or more types of waveforms. However, in the present disclosure, the number of sound source stream signals are counted based on the difference of the sound source from which the sound source stream signals are generated without considering the difference of the waveforms. That is, even if the signal waveform is different, but the sound source from which the signals are generated is the same, the signals are counted as one sound source stream signal. Accordingly, the number of sound inputs 351 to which the sound source stream signals are input are also counted based on the difference of the sound source from which the signals to be input are generated without considering the difference of the waveform of the signals to be input. For example, when the signals having different waveforms and generated from the same sound source are input to two or more independent terminals provided in the amplifier 350, such two or more terminals for sound input are counted as one sound input 351.

### <Hardware Configuration of Amplifier and Sound Source Control Device>

The amplifier 350 may include a control unit 352. The control unit 352 may configure an information processing unit that determines the speakers 360 to be driven and the sound source stream signals driving each speaker 36-1 to 36-N based on the category of each sound source stream signal and the setting of the sound bubble. Specifically, the control unit 352 can be implemented using a microcomputer having a CPU (central processing unit), a memory, and an input/output unit. A computer program (speaker control program) for making the microcomputer function as the control unit 352 is installed and executed in the microcomputer. Thus, the microcomputer functions as the control unit 352. Here, an example in which the control unit 352 is implemented by software will be described herein; however, it is also possible to configure the control unit 352 by preparing dedicated hardware for executing information processing. In addition, the control unit 200 can also be used as an electronic control unit (ECU) used for other vehicle-related controls.

The sound source control device 340 transmits a signal indicating the category of each sound source stream signal and a signal indicating the setting of the sound bubble to the amplifier 350 in addition to the sound source stream signals. The amplifier 350, for example, the control unit 352 of the amplifier 350, determines the speakers to be driven and the sound source stream signal driving each speaker based on the signal indicating the category of each sound source stream signal and the signal indicating the setting of the sound bubble received from the sound source control device 340. The amplifier 350 can determine the speakers 360 to be driven and the sound source stream signal driving each speaker 36-1 to 36-N based on the signal received from the sound source control device, thereby simplifying the control of the speakers 360 performed by the amplifier 350. Here, the sound source control device 340 may transfer to the amplifier 350 a signal indicating the setting of the sound bubble received from the control unit 200 of the sound bubble control device 100 illustrated in FIG. 1A. Specifically, in step S03 of FIG. 1B, the sound source control device 340 may receive a signal indicating the setting of the sound bubble after operation from the control unit 200, and transfer the signal to the amplifier 350.

Similar to the control unit 352, the sound source control device 340 may be implemented using a microcomputer including a CPU (central processing unit), a memory, and an input/output unit, or dedicated hardware for executing each information processing. In addition, the sound source control device 340 can also be used as an electronic control unit (ECU) used for other vehicle-related controls.

### (Specific Example of Sound Sources)

A specific example of the multiple sound sources 330 and in-vehicle infotainment (IVI) will be described. The multiple sound sources 330 are classified into three streams 331 to 333. The stream 331 is a music stream. The sound sources belonging to the music stream 331 include a first tuner, a second tuner, . . . , a first external input, a second external input, and the like. Examples of the first tuner, the second tuner, . . . include various radio tuners such as an AM tuner, an FM tuner and an XM tuner, and a television tuner. Further, examples of the first external input, the second external input, . . . include music reproduction from a mobile music player, music stream reproduction (Wireless Audio Streaming), and music reproduction from an application installed in a smartphone or cell-phone (mobile phone). A mobile music player, a smartphone, and a cell-phone (mobile phone) are wired to the sound source control device 340 installed in a vehicle using a predetermined connection cable, or wirelessly connected thereto via short-range wireless communication or wireless LAN (local area network).

The stream 332 is a navigation (NAVI) stream. The sound sources belonging to the navigation stream 332 include first navigation, second navigation and the like. Examples of the first navigation, the second navigation and . . . include a sound guidance from a navigation device installed in the vehicle and a sound guidance from a navigation application installed in the passenger's mobile communication terminal such as a smartphone. The passenger's mobile communication terminal is wired to the sound source control device 340 installed in the vehicle using a predetermined connection cable, or wirelessly connected thereto via short-range wireless communication or wireless LAN (local area network).

The stream 333 is a telephone stream. The sound sources belonging to the telephone stream 333 include a first call, a first ring, a second call, a second ring and the like. Examples of the first call, the first ring, the second call, the second ring and . . . include a call using a telephone system installed in the vehicle, a ring sound using the telephone system, a call using a call application installed in the passenger's mobile communication terminal, and a ring sound using the call application.

The sound source signals can be output from each of the sound sources 330 described above. The sound source control device 340 receives these sound source signals, and outputs the sound source signals output from multiple sound sources 330 belonging to the stream for each stream 331 to 333 as sound source stream signals. When the sound source signals are output simultaneously from multiple sound sources in the same stream, the sound source control device 340 may operate as follows. The sound source control device 340 may output a representative sound source signal output from the sound source 330 having the highest priority among the sound source signals output simultaneously from the multiple sound sources 330 belonging to the same stream 331 to 333 as a sound stream signal. This can reduce the number of sound inputs to the amplifier 350. This suppresses mixing of the sounds simultaneously reproduced from the multiple sound sources. The priority relationship among the multiple sound sources 330 belonging to the same stream 331 to 333 may be predetermined, and the sound source control device 340 may store the data indicating the priority relationship for each stream 331 to 333.

The multiple sound sources 330 and the sound source control device 340 may be collectively referred to as in-vehicle infotainment 310. The in-vehicle infotainment 310 is an information communication system providing both information (information) and entertainment (entertainment). For example, the sound source 330 and the sound source control device 340 installed in the vehicle, including tuners and a telephone system, excluding external inputs from a smartphone or the like, may be stored in one housing.

### <Sound Bubble Formed in Vehicle Interior>

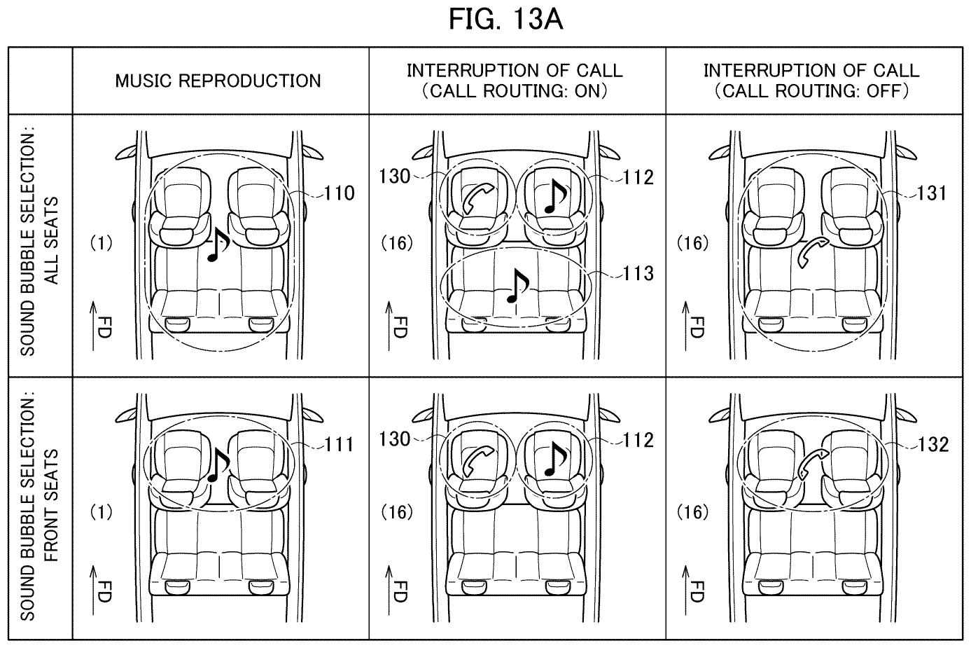

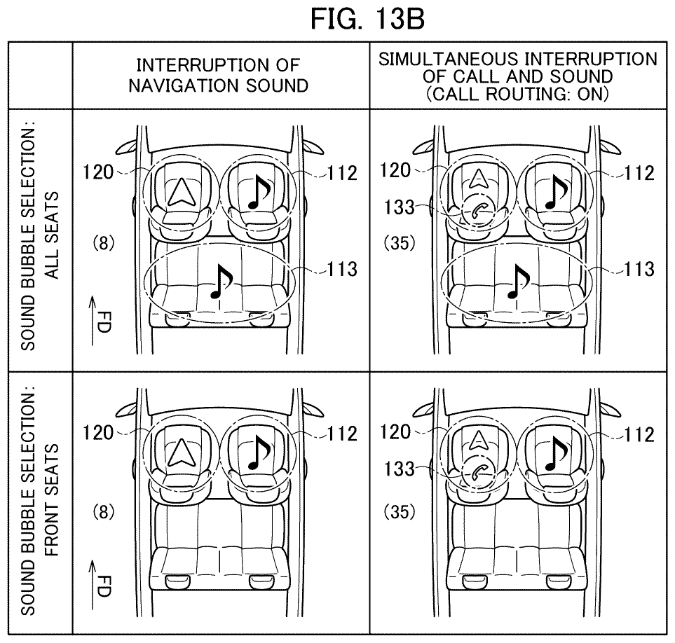

The sound bubble formed in the vehicle interior by the acoustic system 300 will be described for each setting of the sound bubble with reference to FIGS. 13A and 13B. The arrow FD indicates the straight direction of the vehicle. The upper sides of FIGS. 13A and 13B illustrate a case where the sound bubble selection is set to all seats, that is, the sound bubble selection switch 212 is displayed as “ALL”. The lower side of FIGS. 13A and 13B illustrate a case where the sound bubble selection is set to the front seats, that is, the sound bubble selection switch 212 is displayed as “FRONT”.

First, a case where the setting of the sound bubble is the setting illustrated in FIG. 7 will be described. The sound bubble selection switch 212 is set to “ALL” and the telephone selection switch 213 is set to “DRIVER”. “ALL” in the sound bubble selection switch 212 illustrated in FIG. 7 corresponds to the case where the sound bubble selection in FIGS. 13A and 13B is all seats. Therefore, for example, when the sound source belonging to the music stream 331 is reproduced, the music sound bubble 110 is formed in all seats in the vehicle interior, that is, in the area including the driver seat, the passenger seat and the rear seat. In the sound bubble 110, the sound of the sound source belonging to the music stream 331 is heard.

When the sound source belonging to the telephone stream 333, for example, the ring sound, is reproduced in a state in which the music sound bubble 110 is formed, the telephone sound bubble 130 is newly formed in the area including the driver seat (left seat) in the vehicle interior. At this time, since the sound source belonging to the music stream 331 continues to be reproduced, the music sound bubbles 112 and 113 are formed simultaneously in the area including the passenger seat and the rear seat except for the driver seat. Thus, when the telephone selection switch 213 is set to “DRIVER,” that is, “Call Routing” is set to “ON”, the acoustic system 300 forms the sound bubble 130 of the telephone sound source in a limited part of the vehicle interior, in this case, in the area including the driver seat. At the same time, the music sound bubbles 112 and 113 are formed in the other areas in the vehicle interior. In each of the sound bubbles 130, 112 and 113, the sounds of the music and telephone sound sources are heard without mixing each other.

Next, a case where the setting of the sound bubble is the setting illustrated in FIG. 9 will be described. The sound bubble selection switch 212 is set to “ALL” and the telephone selection switch 213 is set to “ALL”. “ALL” in the telephone select switch 213 corresponds to “Call Routing: OFF” in FIG. 13A. In this case, the telephone source has priority over the music source. Specifically, the sound bubble 131 of the telephone sound source is formed in the area including all seats in the vehicle interior, and the sound bubble of the music sound source is not formed. Thus, when the reproduction of the sound source belonging to the telephone stream 333 is started in a state that the music sound bubble 110 is formed, the whole vehicle interior is switched from the music sound bubble 110 to the telephone sound bubble 131.

Next, the sound bubble of the navigation sound source will be described. When the sound source belonging to the navigation stream 332, for example, a sound guidance, is reproduced in the state that the music sound bubble 110 is formed, the navigation sound bubble 120 is newly formed in the area including the driver seat (left seat) in the vehicle interior, as illustrated in FIG. 13B. At this time, since the sound source belonging to the music stream 331 continues to be reproduced, the music sound bubbles 112 and 113 are formed simultaneously in the area including the passenger seat and the rear seat except for the driver seat. Thus, the sound bubble 120 of the sound source belonging to the navigation stream 332 is formed in the area including the driver seat, but not formed in the area including the passenger seat and the rear seat except for the driver seat. The acoustic system 300 simultaneously forms the sound bubbles 120, 112 and 113 of the music and navigation sound sources belonging to the different streams. In each of the sound bubbles 120, 112, and 113, the sounds of the music and navigation sound sources are heard without mixing each other.

In the above description, the navigation sound bubble 120 and the telephone sound bubble 130 are formed in the same area including the driver seat. When the sound source belonging to the navigation stream 332 and the sound source belonging to the telephone stream 333 compete with each other, that is, when the navigation sound bubble and the telephone sound bubble are formed simultaneously, one of the sound bubbles may be given priority over the other one. For example, the images of the navigation and telephone sound bubbles 120 and 133 formed when the telephone is given priority over the navigation are illustrated on the upper right side of FIG. 13B. The telephone sound bubble 133 may be formed in the area close to the ear of the passenger, and at the same time, the navigation sound bubble 120 may be formed in the area surrounding the telephone sound bubble 133. Thus, the navigation and telephone sound bubbles are formed without mixing each other, and the passenger can hear the sounds of the telephone and navigation sound sources in the respective sound bubbles 133 and 120 without mixing each other.

The case where the sound bubble selection in FIGS. 13A and 13B is set to the front seats corresponds to the case where the sound bubble selection switch 212 illustrated in FIGS. 10 and 11 is set to “FRONT”. Therefore, when the sound source belonging to the music stream 331 is reproduced, the music sound bubble 111 is formed in the front seats in the vehicle interior, that is, in the area including the driver seat and the passenger seat, but the sound bubble is not formed in the area including the rear seat. In the sound bubble 111, the sound of the sound source belonging to the music stream 331 is heard. In addition, “Call Routing: ON” and “Call Routing: OFF”, the sound bubble 120 of the navigation sound source, and the competition between the navigation sound bubble 120 and the telephone sound bubble 130 are different in that the sound bubble is not formed in the rear seat compared to the case where the sound bubble selection is set to all seats; however, these are common in other points, and thus a repetitive description thereof will be omitted.

### <Stream of Sound Sources and Category of Sound Sources>

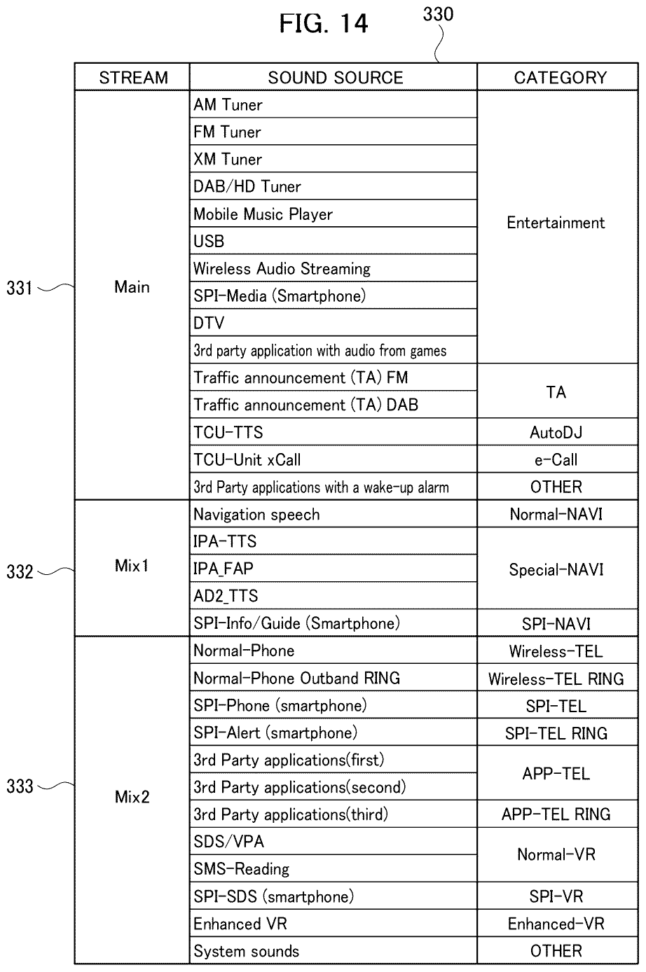

A specific example of the streams 331, 332, and 333 to which each sound source 330 belongs, and the category to which each sound source 330 belongs will be described with reference to FIG. 14. All the sound sources 330 are classified into any of the stream (Main) 331, the stream (Mix 1) 332, and the stream (Mix 2) 333. The stream (Main) 331 is a music stream, the stream (Mix 1) 332 is a navigation stream, and the stream (Mix 2) 333 is a telephone stream.

All the sound sources are classified into multiple categories. The category of sound sources is set for each stream 331, 332, and 333. For example, the sound sources 330 belonging to the music stream 331 are classified into any of Entertainment, TA (traffic announcement, traffic guidance), Auto DJ, e-Call (emergency call), and the other (OTHER). The sound sources 330 belonging to the navigation stream 332 are classified into any of Normal-NAVI (normal navigation), Special-NAVI (special navigation), and SPI-NAVI. The sound sources 330 belonging to the telephone stream 333 are classified into any of Wireless-TEL (wireless call), Wireless-TEL RING (wireless telephone ring), SPI-TEL (special call), SPI-TEL RING (special telephone ring), APP-TEL (smartphone call), APP-TEL RING (smartphone telephone ring), Normal-VR (Voice recognition), SPI-VR, Enhanced-VR, and the other (OTHER). The sound sources 330, and the streams and categories thereof illustrated in FIG. 14 are merely examples and do not limit the invention.

### <Correspondence Relationship Between Combination of Categories, and Identifiers>

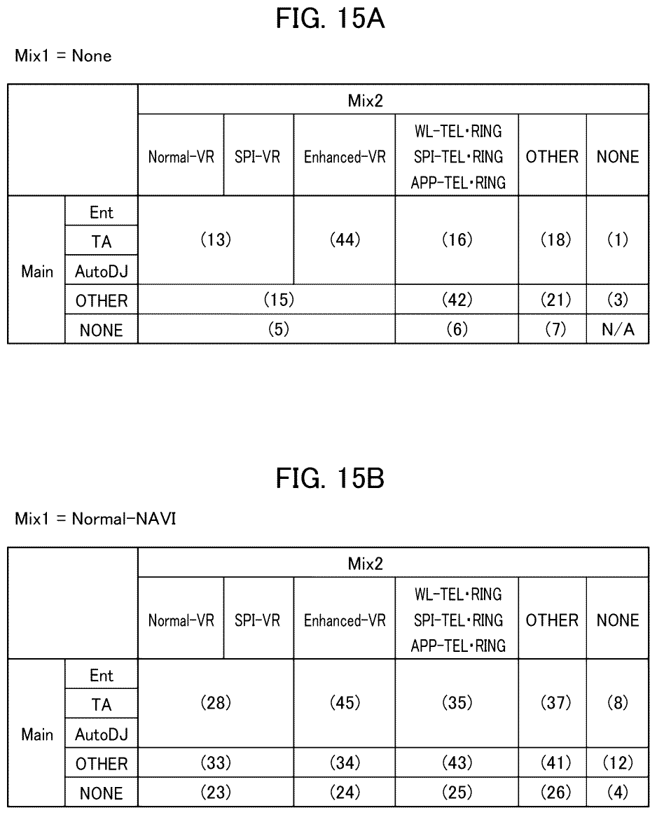

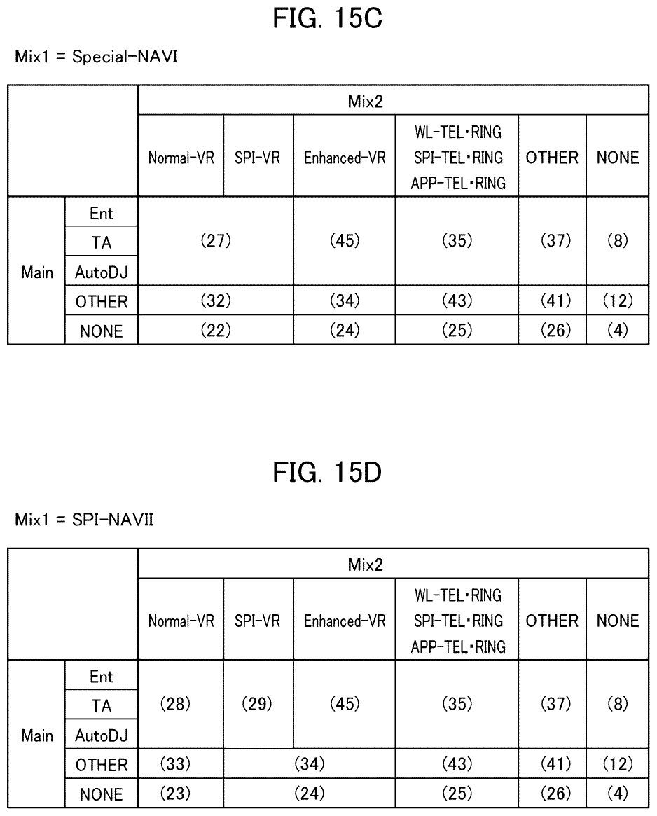

FIGS. 15A to 15D are tables in which a combination of categories of sound sources belonging to three streams (Main, Mix 1, Mix 2) illustrated in FIG. 14 is classified by identifiers (1) to (45). Each of FIG. 15 A to 15D illustrates a combination of each category of the music stream (Main) 331 and each category of the telephone stream (Mix 2) 333. Each of FIGS. 15A to 15D illustrates a category of the navigation stream (Main) 332 (None, Normal-NAVI, Special-NAVI, SPI-NAVI). Combining FIGS. 15A to 15D forms one three-dimensional table illustrating all combinations of the categories belonging to the three streams (Main, Mix 1, Mix 2). For example, the identifier (28) illustrated in FIG. 15B indicates a combination of one of the categories of Entertainment, TA (Traffic announcement) and Auto DJ in the stream (Main), the category (Normal-NAVI) in the stream (Mix 1), and one of the categories of Normal-VR and SPI-VR in the stream (Mix 2).

Here, “None” or “NONE” of the category indicates that the sound source stream signal is not output from the stream. For example, FIG. 15A indicates a case (None) in which the sound source signal is not output from any sound source belonging to the stream (Mix 1). Thus, a combination of the category (NONE) of the stream (Mix 2) and the category (NONE) of the stream (Main) in FIG. 15A indicates a combination in which the sound source stream signal is not output from any stream (Main, Mix 1, Mix 2), which means that there are no speakers to be driven, and therefore an identifier is not assigned.

Referring to the combination tables illustrated in FIGS. 15A to 15D, the control unit 352 of the amplifier 350 can specify the identifier corresponding to the combination of the categories of the sound source stream signals of the respective streams 331, 332, and 333 received from the sound source control device 340. The combination tables illustrated in FIGS. 15A to 15D can be stored in the storage unit 353 provided in the amplifier 350 as illustrated in FIG. 12.

### <Correspondence Table Between Combination of Categories of Sound Sources, and Driving Speakers>

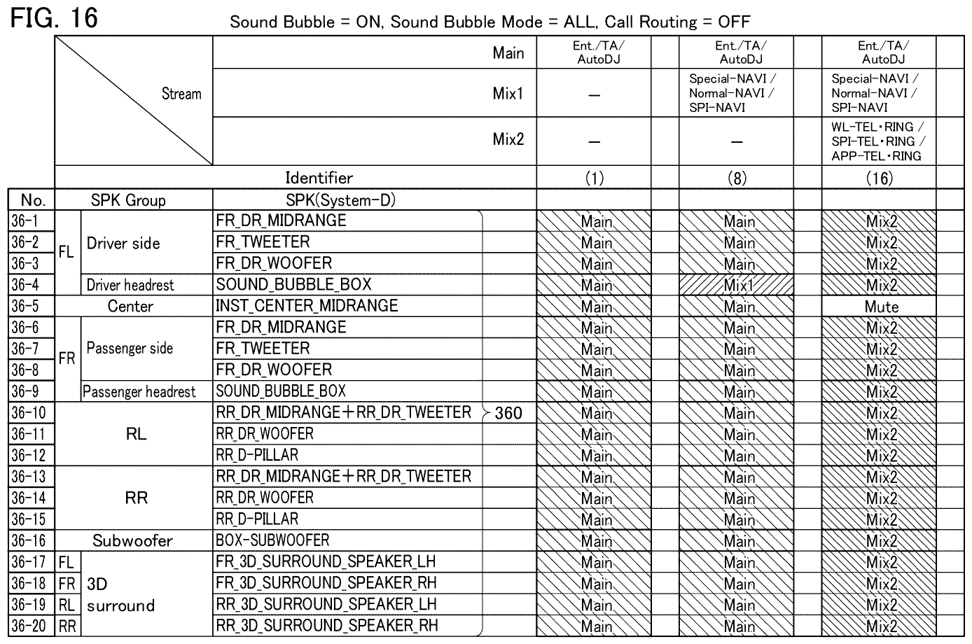

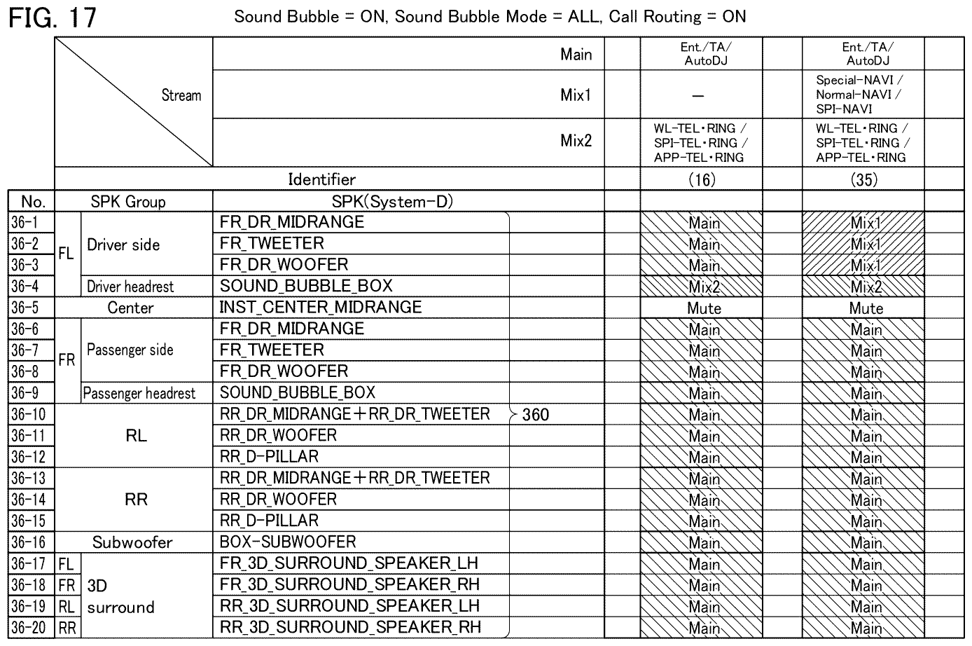

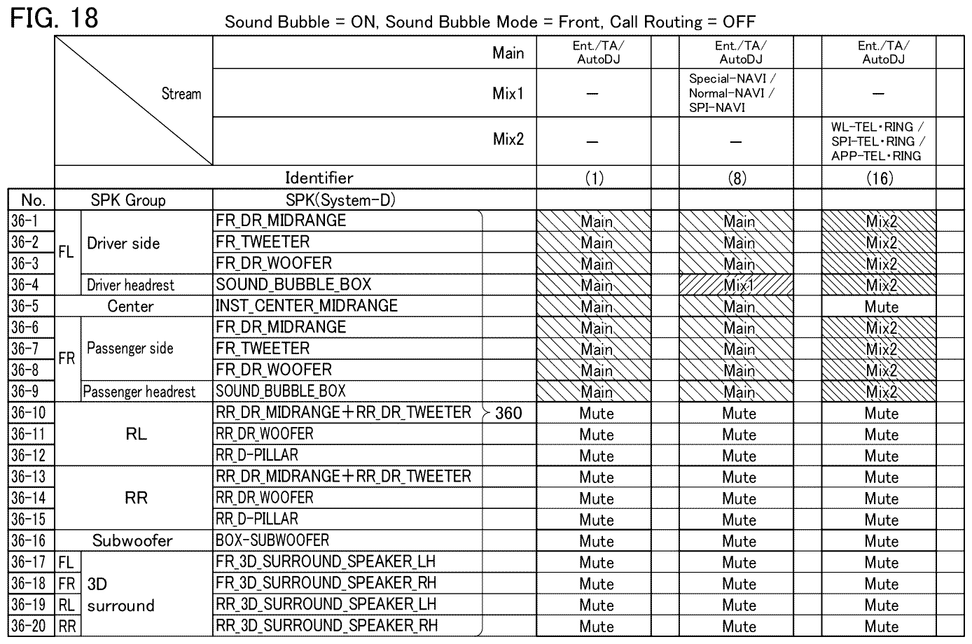

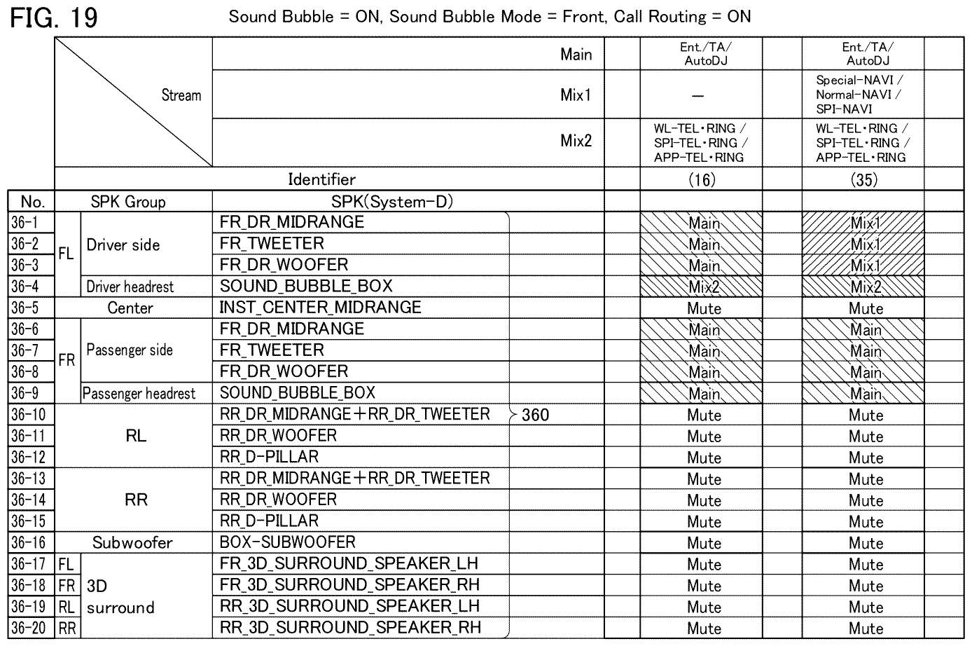

FIGS. 16 to 19 are parts of correspondence tables illustrating a correspondence relationship between a combination of the categories of the sound sources classified by the identifiers (1) to (45) of FIGS. 15A to 15D, and the speakers to be driven and the streams of sound sources driving each speaker. The correspondence tables illustrated in FIGS. 16 to 19 can be stored in the storage unit 353 provided in the amplifier 350. FIGS. 16 to 19 have different settings of the sound bubbles. FIG. 16 illustrates that the start switch 211 is ON (Sound Bubble=ON), the sound bubble selection switch 212 is set to “ALL” (Sound Bubble Mode=ALL), and the telephone selection switch 213 is set to “ALL” (Call Routing=OFF). FIG. 17 differs from FIG. 16 in that the telephone selection switch 213 is set to “DRIVER” (Call Routing=ON). FIG. 18 differs from FIG. 16 in that the sound bubble selection switch 212 is set to “FRONT” (Sound Bubble Mode=Front). FIG. 19 differs from FIG. 16 in that the sound bubble selection switch 212 is set to “FRONT” (Sound Bubble Mode=Front), and the telephone selection switch 213 is set to “DRIVER” (Call Routing=ON).

FIGS. 16 to 19 selectively illustrate the identifiers (1), (8), (16), and (35) corresponding to ten sound bubble states illustrated in FIGS. 13A and 13B from among the identifiers (1) to (45). The identifiers (1), (8), (16), and (35) of FIGS. 16 to 19 correspond to the identifiers (1), (8), (16), and (35) illustrated in FIGS. 13A, 13B, and 15A to 15D, respectively.

Each of FIGS. 16 to 19 illustrates twenty speakers 36-1 to 36-20 installed in the vehicle. The front left seat (FL) is the driver side, and the front right seat (FR) is the passenger side. In the front left seat (FL), three speakers 36-1 to 36-3 are attached to either the driver side door, the driver side of the instrument panel, or the driver side pillar. Further, a headrest speaker 36-4 is attached to the headrest of the driver seat. Thus, the front left seat (FL) is provided with four speakers 36-1 to 36-4 directed to the driver seated in the driver seat. Similarly to the front left seat (FL), the rear right seat (RR) is also provided with four speakers 36-6 to 36-9 directed to the passenger seated in the passenger seat. A speaker 36-5 is also attached to the center of the instrument panel.

Meanwhile, the rear left seat (RL) is provided with three speakers 36-10 to 36-12 directed to the passenger seated in the rear left seat. The rear right seat (RR) is provided with three speakers 36-13 to 36-15 directed to the passenger seated in the rear right seat. A subwoofer 36-16 is attached under the seat or in the trunk room. Four surround speakers 36-17 to 36-20 are attached to the front left seat (FL), the front right seat (FR), the rear left seat (RL), and the rear right seat (RR), respectively.

For each of the identifiers (1), (8), (16), and (35), the speakers 360 to be driven, and the streams 331 to 333 to which the sound source stream signals driving the speakers 36-1 to 36-20 belong will be described.

The identifier (1) in FIG. 16 indicates a case where the sound source stream signal is output from the sound source belonging to any category of Entertainment, TA (Traffic announcement), and Auto DJ of the music stream 331 (Main), and the sound source stream signal is not output from any sound source belonging to the navigation stream 332 (Mix 1) and the telephone stream 333 (Mix 2). The identifier (1) in FIG. 16 corresponds to the identifier (1) in FIG. 15A. As illustrated in FIG. 16, at this time, the amplifier 350 drives all the speakers 36-1 to 36-20 using the sound source stream signals from the music stream 331 (Main). Therefore, the music sound bubble 110 illustrated in the upper left side of FIG. 13A is formed in the vehicle interior.

The identifier (8) illustrated in FIG. 16 indicates a case where the sound source stream signal is output from the sound source belonging to any category of Entertainment, TA (Traffic announcement), and Auto DJ of the music stream 331 (Main), the sound source stream signal is output from the sound source belonging to any category of Normal-NAVI, Special-NAVI, and SPI-NAVI of the navigation stream 332 (Mix 1), and the sound source stream signal is not output from any sound source belonging to the telephone stream 333 (Mix 2). The identifier (8) illustrated in FIG. 16 corresponds to the identifier (8) illustrated in FIGS. 15B to 15D. As illustrated in FIG. 16, at this time, the amplifier 350 drives all the speakers 36-1 to 36-3 and 36-5 to 36-20 except for the headrest speaker 36-4, which is embedded in the headrest of the driver seat, using the sound source stream signals belonging to the music stream 331 (Main), and drives the headrest speaker 36-4 using the sound source stream signals belonging to the navigation stream 332 (Mix 1). Therefore, the music sound bubbles 112 and 113 and the navigation sound bubble 120 illustrated in the upper left side of FIG. 13B are formed simultaneously in the vehicle interior.

The identifier (16) illustrated in FIG. 16 indicates a case where the sound source stream signal is output from the sound source belonging to any category of Entertainment, TA (Traffic announcement), and Auto DJ of the music stream 331 (Main), the sound source stream signal is output from the sound source belonging to any category of WL-TEL, WL-TEL RING, SPI-TEL, SPI-TEL RING, APP-TEL, and APP-TEL RING of the telephone stream 333 (Mix 2), and the sound source stream signal is not output from any sound source belonging to the navigation stream 332 (Mix 1). The identifier (16) illustrated in FIG. 16 corresponds to the identifier (16) illustrated in FIG. 15A. At this time, the amplifier 350 drives all the speakers 36-1 to 36-4 and 36-6 to 36-20 except for the speaker 36-5, which is positioned in the center of the instrument panel, using the sound source stream signals belonging to the telephone stream 333 (Mix 2), and does not drive the speaker 36-5. Therefore, the telephone sound bubble 131 illustrated in the upper right side of FIG. 13A is formed in the vehicle interior.

The identifier (16) in FIG. 17 indicates the same combination as the identifier (16) in FIG. 16. However, the identifier (16) in FIG. 17 differs from FIG. 16 in that the telephone select switch 213 is set to “DRIVER” (Call Routing=ON). The identifier (16) in FIG. 17 corresponds to the identifier (16) in FIG. 15A. At this time, the amplifier 350 drives all the speakers 36-1 to 36-4 and 36-6 to 36-20 except for the speaker 36-5, which is positioned in the center of the instrument panel, and does not drive the speaker 36-5. The amplifier 350 drives the headrest speaker 36-4 using the sound source stream signals belonging to the telephone stream 333 (Mix 2), and the speakers 36-1 to 36-3 and 36-6 to 36-20 using the sound source stream signals belonging to the music stream 331 (Main). Therefore, the telephone sound bubble 130 and the music sound bubbles 112 and 113 illustrated in the upper center of FIG. 13A are formed simultaneously in the vehicle interior.

The identifier (35) in FIG. 17 indicates a case where the sound source stream signal is output from the sound source belonging to any category of Entertainment, TA (Traffic announcement), and Auto DJ of the music stream 331 (Main), the sound source stream signal is output from the sound source belonging to any category of Normal-NAVI, Special-NAVI, and SPI-NAVI of the navigation stream 332 (Mix 1), and the sound source stream signal is output from the sound source belonging to any category of WL-TEL, WL-TEL RING, SPI-TEL, SPI-TEL RING, APP-TEL, and APP-TEL RING of the telephone stream 333 (Mix 2). At this time, the amplifier 350 drives all the speakers 36-1 to 36-4 and 36-6 to 36-20 except for the speaker 36-5, which is positioned in the center of the instrument panel, and does not drive the speaker 36-5. The amplifier 350 drives the headrest speaker 36-4 using the sound source stream signals belonging to the telephone stream 333 (Mix 2), the speakers 36-1 to 36-3 using the sound source stream signals belonging to the navigation stream 332 (Mix 1), and the speakers 36-6 to 36-20 using the sound source stream signals belonging to the music stream 331 (Main). Therefore, as illustrated in the upper right side of FIG. 13B, the telephone sound bubble 133, the navigation sound bubble 120 surrounding the telephone sound bubble 133, and the music sound bubbles 112 and 113 are formed simultaneously in the vehicle interior.

Meanwhile, the identifiers (1), (8), (16) and (35) in FIGS. 18 and 19 are the same combination of the categories of the sound sources as the identifiers (1), (8), (16) and (35) in FIGS. 16 and 17, respectively. However, the settings of the sound bubbles in FIGS. 18 and 19 are different from those in FIGS. 16 and 17 (Sound Bubble Mode=ALL) in that the sound bubble selection switch 212 is set to “FRONT” (Sound Bubble Mode=Front). Therefore, among the multiple speakers 36 to 1 to 36-20, the other speakers 36-9 to 36-20 except for the speakers directed to the front seats (FL, FR) are not driven (Mute) regardless of the combination of the categories. At this time, as illustrated in the lower sides of FIGS. 13A and 13B, the sound bubbles 111, 112, 120, 130, 132 and 133 when the sound bubble selection is set to the front seats are formed in the vehicle interior.

As illustrated in FIGS. 16 to 19, the amplifier 350 may have a correspondence table between a combination of the categories of the respective sound source stream signals, and the speakers 360 to be driven and the sound source stream signal driving each speaker 36-1 to 36-20. The amplifier 350 can determine the speakers 36-1 to 36-20 to be driven, and the sound source stream signal driving each of the speakers 36-1 to 36-20 with reference to the correspondence table. This simplifies the control of the speakers 360 performed by the amplifier 350.

As described above, according to the third embodiment, the following effects are obtained. For example, the sound bubble 130 of the sound source belonging to the telephone stream 333 (Mix 2) at the time of “Call Routing: ON” illustrated in FIG. 13A, and the sound bubble 120 of the sound source belonging to the navigation stream 332 (Mix 1) illustrated in FIG. 13B are limited to only the driver seat, which is one of the seats in the vehicle interior. Thus, when the sound bubble of the sound reproduced from the sound source belonging to the first stream is limited only to one of the seats in the vehicle interior (driver seat), the amplifier 350 assigns the first sound source stream signal output from the sound source belonging to the first stream to the first speaker directed to the passenger of the driver seat, and assigns the second sound source stream signal output from the sound source belonging to the second stream (for example, music) to the second speaker directed to the passenger of the other seats (the passenger seat and the rear seat). As illustrated in the identifiers (8), (16) and (35) of FIGS. 16 to 19, the amplifier 350 drives the first and second speakers simultaneously, using the first and second sound source stream signals. As illustrated in FIGS. 13A and 13B, the sound bubble of the sound reproduced from the sound source belonging to the first stream and the sound bubble of the sound reproduced from the sound source belonging to the second stream can be separated from each other and formed simultaneously. That is, the sound bubbles in which two different sounds are heard can be formed simultaneously. Each sound can be heard clearly in each sound bubble without mixing the two sounds.

As illustrated in FIG. 13B, when the sound bubble 133 of the first sound source stream signal and the sound bubble 120 of the second sound source stream signal are formed in the area including the passenger who is seated in a specific seat (driver seat in this case) in the vehicle interior, the amplifier 350 assigns the first sound source stream signal having a higher priority to the headrest speaker 36-4 close to the ear of the passenger, and assigns the first sound source stream signal having a lower priority to the speakers 36-1 to 36-3 far from the ear of the passenger, as indicated in the identifier (35) of FIG. 17. Thus, when the sound bubbles of two sound sources directed to a specific passenger and belonging to the different streams compete with each other, the speakers to be assigned are assigned according to the distance from the ear of the passenger. The speakers having different distances to the ear of the passenger are assigned according to the priority of the first and second sound source stream signals. Thus, as illustrated in FIG. 13B, the sound bubbles 133 and 120 of the first and second sound source stream signals can be formed in the area including the driver seat. The passenger can hear the sounds of the first and second sound source stream signals according to the priority.

When the multiple speakers 36-1 to 36-4 directed to the passenger (for example, the driver) seated in a specific seat in the vehicle interior are driven simultaneously using the multiple sound source stream signals (for example, navigation and phone), the amplifier 350 assigns the sound source stream signal having a higher priority (telephone) to the speaker 36-4 close to the ear of the passenger, and the sound source stream signal having a lower priority to the speakers 36-1 to 36-3 far from the ear of the passenger. By assigning the speakers having different distances to the ear of the passenger according to the priority of the sound source stream signals, the passenger can hear multiple sounds according to the priority of the sound source stream signals.

The multiple speakers directed to the passenger seated in a specific seat in the vehicle interior include the headrest speakers 36-4 and 36-9 attached to the headrest of the specific seat, and the specific seat speakers 36-1 to 36-3 and 36-6 to 36-8 attached to the door closest to the specific seat, the instrument panel on the specific seat side, or the pillar on the specific seat side. The amplifier assigns the sound source stream signals output from the sound sources belonging to the telephone stream 331 (Mix 2) to the headrest speakers 36-4 and 36-9, and assigns the sound source stream signals output from the sound sources belonging to the navigation stream 332 (Mix 1) to the specific seat speakers. Since the sound of the sound source belonging to the telephone having a higher priority than the navigation can be reproduced from the headrest speaker 36-4 which is closer to the ear of the passenger, the amplifier 350 can drive the speakers 360 in an appropriate manner.

The third embodiment has been described as above; however, the descriptions and drawings that form part of this disclosure should not be understood as limiting the invention. Various alternative embodiments, examples, and operation techniques will become apparent to those skilled in the art from this disclosure.

For example, instead of the signal identifying the category of each sound source stream signal, the sound source control device 340 may transmit to the amplifier 350, a signal identifying the sound source 330 which outputs each sound source stream signal. The sound source control device 340 can identify the category of the sound source 330 from the signal identifying the sound source 330 based on the correspondence table between the sound source 330 and the category illustrated in FIG. 14, for example. Therefore, the amplifier 350 can determine the speakers to be driven and the sound source stream signal driving each speaker based on the signal identifying the sound source and the signal indicating the setting of the sound bubble received from the sound source control device 340. This simplifies the control of the speakers 360 performed by the amplifier 350.

As illustrated in FIG. 14, the case has been described in which the sound sources 330 are classified into one of the music stream 331 (Main), the navigation stream 332 (Mix 1), and the telephone stream 331 (Main). However, the sound sources 330 may be classified into 2 or 4 or more streams.

In the third embodiment, the amplifier 350 does not drive a speaker directed to the area in the vehicle interior where the sound bubble is not formed. However, the present disclosure is not limited thereto, and the amplifier 350 may drive a speaker directed to the area in the vehicle interior where the sound bubble is not formed, using an active noise cancellation signal whose phase is opposite to the sound source stream signals for driving other speakers. As a result, the sound leaked from the area where the sound bubble is formed to the area where the sound bubble is not formed can be canceled by the active noise cancellation signal, thereby enabling the outer edges of the sound bubble to be accurately controlled.

### REFERENCE SIGNS LIST

100 Sound bubble control device
110 to 113, 120, 130 to 133 Sound bubble
220 Layout Diagram
211 Start switch (information indicating start or stop of sound bubble control device)
221, 222, 223 Seat
221 Driver seat
231 to 233 Sound source icon
234 Animation in which ripples spread
235, 33N Mute icon
240 Sentence
330 Sound source
331 Music stream
332 Navigation stream
333 Telephone stream
350 Amplifier
351 Sound input
360 Speaker
36-1 to 36-3, 36-6 to 36-8 Specific seat speaker
36-4, 36-9 Headrest speaker
400 Touch panel (display)

1. An acoustic system, comprising:
a sound source control device configured to output multiple sound source stream signals; and
an amplifier configured to have at least the same number of sound inputs as the sound source stream signals, and drive multiple speakers installed in a vehicle using the sound source stream signals input to each of the sound inputs,
wherein the sound source control device classifies sound sources greater in number than the sound source stream signals into multiple streams, and outputs sound source signals output from multiple sound sources belonging to the streams for each stream as the sound source stream signals, and
wherein the amplifier determines the speakers to be driven and the sound source stream signals driving each speaker, based on a category of each sound source stream signal and a setting of a sound bubble that is an area in a vehicle interior where a sound reproduced from the multiple speakers is heard.

2. The acoustic system according to claim 1, wherein the sound source control device outputs a representative sound source signal output from a sound source having a highest priority among sound source signals output simultaneously from multiple sound sources belonging to the same stream as one of the sound stream signals.

3. The acoustic system according to claim 1, wherein when multiple speakers directed to a passenger seated in a specific seat in the vehicle interior are driven simultaneously using multiple sound source stream signals, the amplifier assigns a sound source stream signal having a higher priority to a speaker close to an ear of the passenger, and a sound source stream signal having a lower priority to a speaker far from an ear of the passenger.

4. The acoustic system according to claim 3, wherein the multiple speakers directed to a passenger seated in a specific seat in the vehicle interior include a headrest speaker attached to a headrest of the specific seat, and a specific seat speaker attached to a door closest to the specific seat, an instrument panel on the specific seat side, or a pillar on the specific seat side, and
wherein the amplifier assigns a sound source stream signal output from a sound source belonging to a telephone stream to the headrest speaker, and assigns a sound source stream signal output from a sound source belonging to a navigation stream to the specific seat speaker.

5. The acoustic system according to claim 1, wherein the amplifier has a correspondence table between a combination of categories of respective sound source stream signals, and speakers to be driven and a sound source stream signal driving each speaker, and determines the speakers to be driven and the sound source stream signal driving each speaker with reference to the correspondence table.

6. The acoustic system according to claim 1, wherein the sound source control device transmits a signal indicating a category of each sound source stream signal and a signal indicating a setting of the sound bubble to the amplifier, and
wherein the amplifier determines the speakers to be driven and a sound source stream signal driving each speaker based on the signal indicating a category of each sound source stream signal and the signal indicating the setting of the sound bubble received from the sound source control device.

7. The acoustic system according to claim 1, wherein the sound source control device transmits to the amplifier, a signal identifying a sound source which outputs each sound source stream signal and a signal indicating a setting of the sound bubble, and
wherein the amplifier determines the speakers to be driven and a sound source stream signal driving each speaker based on the signal identifying the sound source and the signal indicating the setting of the sound bubble received from the sound source control device.

8. The acoustic system according to claim 1, wherein the multiple sound sources are classified into any of a music stream, a navigation stream, and a telephone stream.

9. The acoustic system according to claim 1, wherein the amplifier drives the speaker directed to an area in the vehicle interior where the sound bubble is not formed, using an active noise cancellation signal whose phase is opposite to the sound source stream signals for driving other speakers.

10. The acoustic system according to claim 1, wherein when the sound bubble of a sound reproduced from a sound source belonging to a first stream is limited only to some of seats in the vehicle interior, the amplifier assigns a first sound source stream signal output from a sound source belonging to the first stream to a first speaker directed to a passenger of some of the seats and assigns a second sound source stream signal output from a sound source belonging to a second stream to a second speaker directed to a passenger of the other seats, and drives the first and second speakers simultaneously, using the first and second sound source stream signals.

11. The acoustic system according to claim 1, wherein when a sound bubble of the first sound source stream signal and a sound bubble of the second sound source stream signal are formed in an area including a passenger who is seated in a specific seat in the vehicle interior, the amplifier assigns the first sound source stream signal having a higher priority to a speaker close to an ear of the passenger, and assigns the first sound source stream signal having a lower priority to a speaker far from an ear of the passenger.
